(19) United States
(12) Patent Application Publication
(10) Pub. No.: US 2017/0356696 A1
(43) Pub. Date: Dec. 14, 2017

(54) COMPLEX PIN FIN HEAT EXCHANGER

(71) Applicant: HAMILTON SUNDSTRAND CORPORATION, Charlotte, NC (US)

(72) Inventors: Mark A. Zaffetti, Suffield, CT (US); Jerermy M. Strange, Windsor, CT (US)

(21) Appl. No.: 15/180,576

(22) Filed: Jun. 13, 2016

(51) Int. Cl. F28F 3/02; B23P 15/26; F28D 9/00; B23K 26/342; B33Y 80/00; B33Y 10/00

(52) U.S. Cl. CPC F28F 3/022; F28D 9/0081; B23K 26/342; B23P 15/26; B33Y 10/00; F28F 2215/10; B33Y 80/00

(57) ABSTRACT

A heat exchanger has a plurality of outer walls and at least one inner wall. A first fluid port communicates a first fluid into a chamber on one side of the at least one inner wall and a second port communicates a second fluid into a second chamber on an opposed side of the at least one inner wall. A plurality of pins extends from the inner wall in at least one of the chambers. The plurality of pins has a generally frusto-conical outer surface. A method is also disclosed and claimed.

### BACKGROUND OF THE INVENTION

This application relates to a heat exchanger having complex shaped pins.

Heat exchangers are known and utilized in any number of applications. One type of heat exchanger is a pin fin heat exchanger. In such a heat exchanger, a first fluid flows through a first chamber and a second fluid flows through a second chamber. A plate separates the two chambers and the fluids exchange heat through the plate.

To increase the heat transfer efficiency, it is known to have pins extending between adjacent plates. Historically, the plates and fins have had a constant cross-sectional thickness.

Additive manufacturing techniques have been developed. In an additive manufacturing system, a tool lays down material in layers and forms components. While it has been proposed to form heat exchangers from additive manufacturing techniques, a pin fin heat exchanger has not been formed by additive manufacturing techniques.

### SUMMARY OF THE INVENTION

A heat exchanger has a plurality of outer walls and at least one inner wall. A first fluid port communicates a first fluid into a chamber on one side of the at least one inner wall and a second port communicates a second fluid into a second chamber on an opposed side of the at least one inner wall. A plurality of pins extends from the inner wall in at least one of the chambers. The plurality of pins has a generally frusto-conical outer surface.

A method is also disclosed and claimed.

These and other features may be best understood from the following drawings and specification.

### BRIEF DESCRIPTION OF THE DRAWINGS

FIG. 1 schematically shows a heat exchanger.

FIG. 2 is a cross-sectional view through the FIG. 1 heat exchanger.

FIG. 3A shows a first pin embodiment.

FIG. 3B shows an alternative embodiment.

FIG. 3C shows an alternative embodiment.

FIG. 3D shows an alternative embodiment.

FIG. 3E shows an alternative embodiment.

FIG. 3F shows yet another alternative embodiment.

FIG. 4 shows a manufacturing technique.

### DETAILED DESCRIPTION

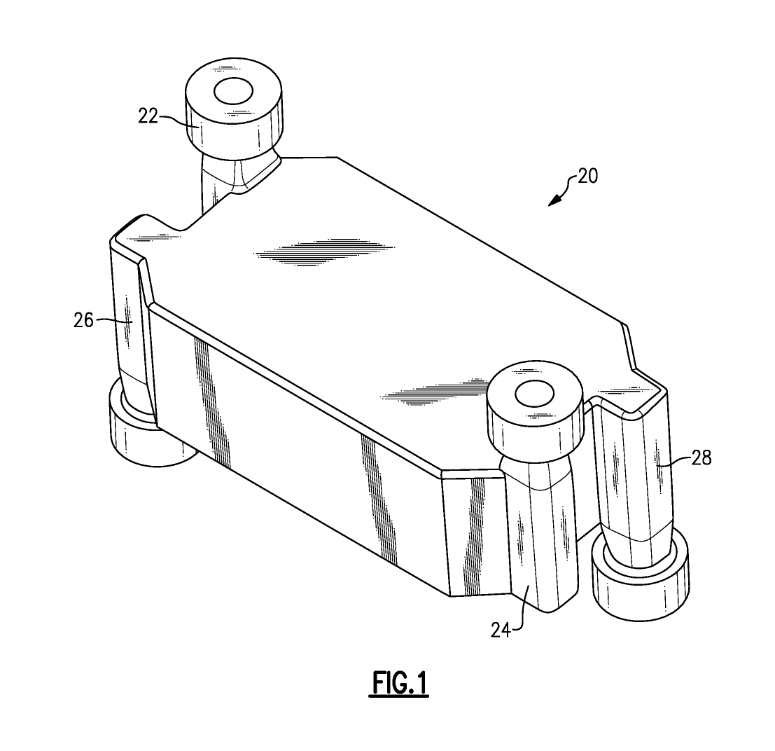

FIG. 1 shows a heat exchanger 20 having a first port 22, which may be an inlet port, and communicating fluid to an outlet port 24. A second fluid enters through an inlet port 26 and exits through an outlet port 28.

While a particular arrangement is disclosed, the parallel flow of the two fluids as illustrated can be replaced with a cross-flow application. In such an application, the port 28 could be an inlet and port 26 an outlet. For that matter, a number of other inlet/outlet port arrangements and configurations could be utilized.

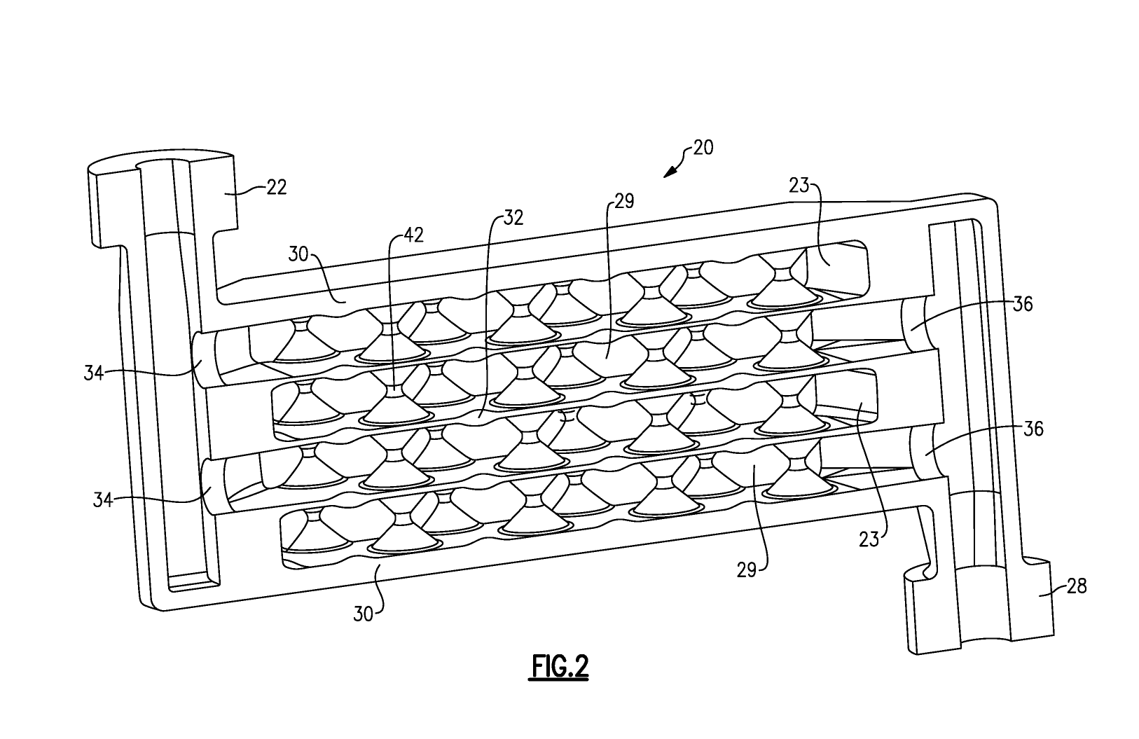

FIG. 2 is a cross-sectional view through the heat exchanger 20. As can be seen, the port 22 provides fluid to chambers 23 and the second port 28 provides fluid to chambers 29. Outer walls 30 are formed along with intermediate or inner walls 32. As can be appreciated, the inner walls 32 separate chambers 23 and 29. As known, heat is exchanged between the fluids in the chambers through the walls 32.

As shown in this figure, ports 34 communicate from the port 22 into the chambers 23. Similarly, ports 36 communicate with chambers 29 to the ports 28.

Pins 42 extend between the walls 30 and 32. Pins also extend between walls 32.

As can be appreciated in this figure, the pins 42 have enlarged surfaces adjacent the walls 30 and 32 and a thinner portion in the center.

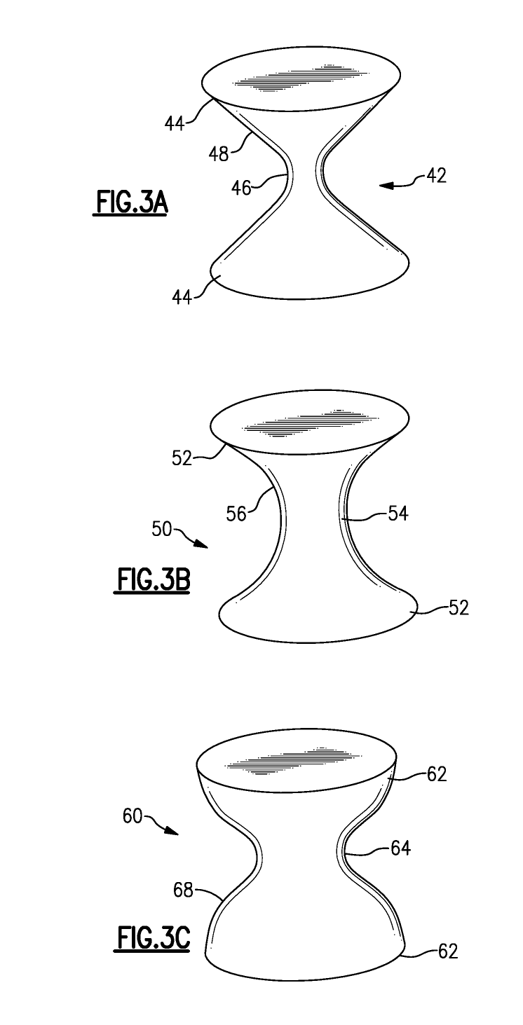

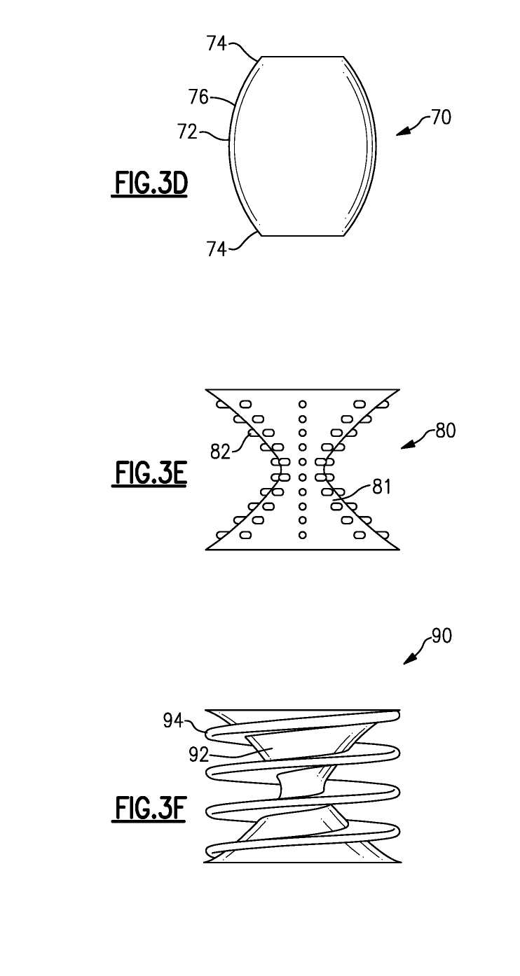

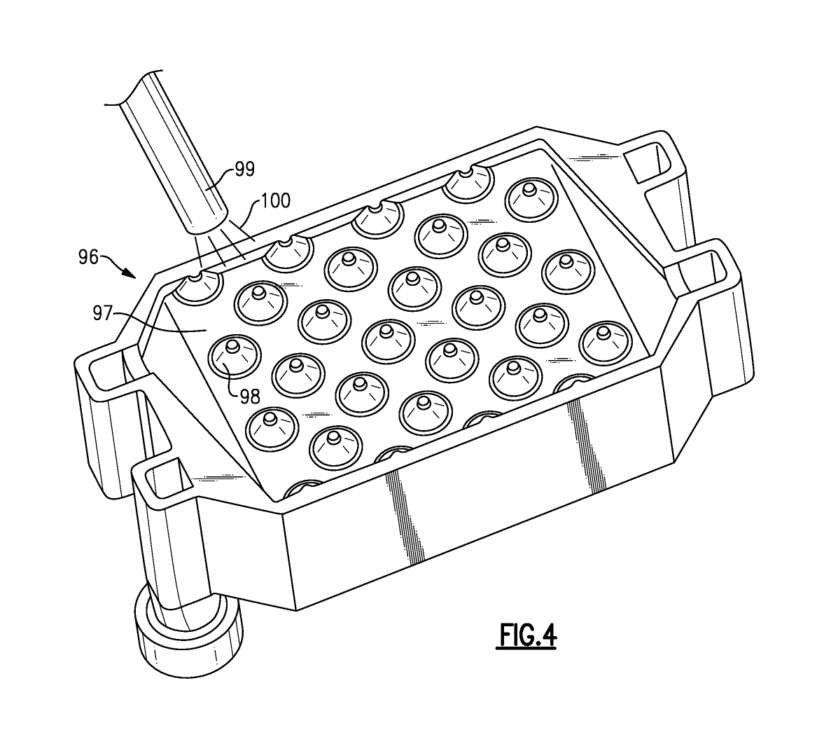

FIG. 3A shows the pin embodiment 42. The outer portions 44, which are actually in contact with the walls 30 and 32, are larger and extend in a frusto-conical direction to a smaller central portion 46. The outer surfaces 48 in this embodiment are straight, or along a constant angle. Thus, the shape is actually frusto-conical.

FIG. 3B shows a generally frusto-conical pin embodiment 50. Here again, the outer portions 52 are larger than the central portion 56. However, the term “generally conical” can be seen to be a concave curving surface 56.

FIG. 3C shows another pin embodiment 60 having outer portions 62 and a thinner central portion 64. The generally frusto-conical section 68 is a convex curve.

FIG. 3D shows an embodiment 70 wherein the outer portions 74 are smaller than the central portion 72. Here again, the outer surface 76 is generally frusto-conical on both sides of the portion 72.

For purposes of this application, the term “generally frusto-conical” means that the size either increases or decreases from one end toward the center and then moves back to either a larger or smaller size as shown across these embodiments.

FIG. 3E shows yet another embodiment 80 wherein the frusto-conical surface 81 is provided with a plurality of spikes 82.

FIG. 3F shows an embodiment 90 where the generally frusto-conical surface 92 is formed with a spiral rib 94. The discrete surfaces are spikes.

It should be appreciated that any number of other shapes may be provided on the outer surface of the pins. Stated generally, there are discrete surfaces extending outwardly of the generally frusto-conical shapes to increase the heat transfer effect.

The pin embodiments, as disclosed above, would be difficult to manufacture using standard manufacturing techniques. FIG. 4 shows a manufacturing technique for forming the heat exchanger, as disclosed. Here, an intermediate heat exchanger 96 is being formed. There are plates 97 and pins 98. An additive manufacturing tool 99 is shown laying down material 100. As known, material is deposited in layers and very complex shapes can be achieved.

Any number of additive manufacturing techniques can be utilized to form a heat exchanger as disclosed. In one embodiment, direct metal selective laser melting may be used.

This disclosure could be summarized as a heat exchanger 20 has a plurality of outer walls and at least one inner wall (walls 30 and 32), a first fluid port communicating a first fluid into a chamber 23 on one side of at least one inner wall and a second port communicating a second fluid into a second chamber 29 on an opposed side of the at least one inner wall. A plurality of pins extend from the at least one inner wall in at least one of chambers 23/29, the plurality of pins have a generally frusto-conical shape.

A method of forming a heat exchanger 20 includes laying down layers of material 100 with an additive manufacturing process and forming a plurality of outer walls and at least one inner wall. The method also includes forming a first fluid port for communicating a first fluid into a chamber formed on one side of at least one inner wall and forming a second port communicating a second fluid into a second chamber formed on an opposed side of the at least one inner wall. The method further includes the step of forming a plurality of pins extending from at least one inner wall in at least one of the chambers, the plurality of pins are formed to have a generally frusto-conical shape.

Although an embodiment of this invention has been disclosed, a worker of ordinary skill in this art would recognize that certain modifications would come within the scope of this invention. For that reason, the following claims should be studied to determine the true scope and content of this invention.

1. A heat exchanger comprising:
a plurality of outer walls and at least one inner wall, a first fluid port communicating a first fluid into a chamber on one side of said at least one inner wall and a second port communicating a second fluid into a second chamber on an opposed side of said at least one inner wall, and a plurality of pins extending from said at least one inner wall in at least one of said chambers, said plurality of pins having a generally frusto-conical shape.

2. The heat exchanger as set form in claim 1, wherein there are a plurality of said inner walls and said plurality of pins extending between two of said plurality of inner walls such that there is an outer pin portion in contact with two of said walls and a central pin portion.

3. The heat exchanger as set form in claim 1, wherein said generally frusto-conical shape extends from an enlarged surface in contact with one of said outer walls and said inner wall, and extending to a smaller central portion such that there are generally frusto-conical shapes on each side of said central portion.

4. The heat exchanger as set form in claim 3, wherein said generally frusto-conical surfaces are true frusto-conical surfaces extending along a constant angle.

5. The heat exchanger as set form in claim 3, wherein said generally frusto-conical surfaces are curved.

6. The heat exchanger as set form in claim 5, wherein said curves are convex.

7. The heat exchanger as set form in claim 5, wherein said curves are concave.

8. The heat exchanger as set form in claim 1, wherein said generally frusto-conical shape result in there being a greater cross-sectional area at a central portion of said plurality of pins, and extending to smaller cross-sectional areas in contact with said outer wall and said inner walls.

9. The heat exchanger as set form in claim 1, wherein there being surfaces formed extending outwardly of said generally frusto-conical surfaces.

10. The heat exchanger as set form in claim 9, wherein said surfaces are discrete surfaces.

11. The heat exchanger as set forth in claim 10, wherein said discrete surfaces are spikes.

12. The heat exchanger as set form in claim 9, wherein said surfaces are at least one surface extending outwardly and continuing around said generally frusto-conical surfaces.

13. The heat exchanger as set form in claim 1, wherein said heat exchanger is formed by additive manufacturing techniques.

14. A method of forming a heat exchanger comprising:
laying down layers with an additive manufacturing process and forming a plurality of outer walls and at least one inner wall forming a first fluid port for communicating a first fluid into a chamber formed on one side of said at least one inner wall and forming a second port communicating a second fluid into a second chamber formed on an opposed side of said at least one inner wall, and forming a plurality of pins extending from said at least one inner wall in at least one of said chambers, said plurality of pins formed to have a generally frusto-conical shape.

15. The method of forming a heat exchanger as set form in claim 14, including the step of forming a plurality of said inner walls and said plurality of pins formed between two of said plurality of inner walls such that there is an outer pin surface in contact with two of said walls and a central pin portion.

16. The method of forming a heat exchanger as set form in claim 14, wherein said generally frusto-conical shape extends from an enlarged surface in contact with one of said outer walls and said at least one inner wall to a smaller central portion such that there are generally frusto-conical shapes on each side of said central portion.

17. The method of forming a heat exchanger as set form in claim 16, wherein said generally frusto-conical surfaces are true frusto-conical surfaces extending along a constant angle.

18. The method of forming a heat exchanger as set form in claim 16, wherein said generally frusto-conical surfaces are curved.

19. The method of forming a heat exchanger as set form in claim 14, wherein said generally frusto-conical surfaces result in there being a greater cross-sectional area at a central portion of said plurality of pins, and extending to smaller cross-sectional areas in contact with said outer wall and said inner wall.

20. The method of forming a heat exchanger as set form in claim 14, wherein there being surfaces formed extending outwardly of said generally frusto-conical surfaces.
